(19) United States
(12) Patent Application Publication
(10) Pub. No.: US 2011/0073495 A1
(43) Pub. Date: Mar. 31, 2011

(54) WATER ANALYSIS

(75) Inventors: Huijun Zhao, Highland Park (AU); Shanqing Zhang, Mudgeeraba (AU)

(73) Assignee: AQUA DIAGNOSTIC PTY LTD, South Melbourne (AU)

(21) Appl. No.: 12/520,227

(22) PCT Filed: Dec. 21, 2007
(86) PCT No.: PCT/AU2007/001987

§ 371 Date: Jun. 23, 2010

(30) Foreign Application Priority Data
Dec. 22, 2006 (AU) AU 200607134

(51) Int. Cl. G01N 27/403; G01N 27/26

(52) U.S. Cl. 205/782; 204/400

(57) ABSTRACT

A method of determining chemical oxygen demand (COD) of a water sample which is useful in a probe configuration includes the steps of a) applying a constant potential bias to a photoelectmchemical cell, having a photoactive working electrode optionally a reference electrode and a counter electrode, and containing a supporting electrolyte solution; b) illuminating the working electrode with a light source and recording the background photocurrent produced at the working electrode from the supporting electrolyte solution; c) adding a water sample, to be analysed, to the photoelectrochemical cell; d) illuminating the working electrode with a light source and recording the steady state photocurrent produced with the sample; e) determining the chemical oxygen demand of the water sample using the formula (I): where δ is the Nernst diffusion layer thickness, D is the diffusion coefficient, A is the electrode area, F the Faraday constant and iss the steady state photocurrent. The method can accommodate a broad range of light intensity and pH.

### FIELD OF THE INVENTION

This invention relates to a new method for determining oxygen demand of water using photoelectrochemical cells. In particular, the invention relates to an improved direct photoelectrochemical method of determining chemical oxygen demand of water samples using a titanium dioxide nanoparticulate semiconductive electrode. It is particularly adapted to a use in a probe configuration

### BACKGROUND TO THE INVENTION

Nearly all domestic and industrial wastewater effluents contain organic compounds, which can cause detrimental oxygen depletion (or demand) in waterways into which the effluents are released. This demand is due largely to the oxidative biodegradation of organic compounds by naturally occurring microorganisms, which utilize the organic material as a food source. In this process, organic carbon is oxidised to carbon dioxide, while oxygen is consumed and reduced to water.

Oxygen demand assay based on photoelectrochemical degradation principles has been previously disclosed in patent specification WO2004088305 where the measurement was based on exhaustive degradation principles.

It is an object of the present invention to develop an analyzer based on non-exhaustive degradation principles. It is another object of this invention to develop a probe type COD analyzer.

### BRIEF DESCRIPTION OF THE INVENTION

To this end the present invention provides a method of determining chemical oxygen demand (COD) of a water sample, comprising the steps of
a) applying a constant potential bias to a photoelectrochemical cell, having a photoactive working electrode and a counter electrode, and containing a supporting electrolyte solution;
b) illuminating the working electrode with a light source and recording the background photocurrent produced at the working electrode from the supporting electrolyte solution;
c) adding a water sample, to be analysed, to the photoelectrochemical cell;
d) illuminating the working electrode with a light source and recording the steady state photocurrent produced with the sample;
e) determining the chemical oxygen demand of the water sample using the formula

$$[ COD ] = \frac{δ}{FAD} \times 8000 {i}_{ss}$$

where δ is the Nernst diffusion layer thickness, D is the diffusion coefficient, A is the electrode area, F the Faraday constant and iₛₛ the steady state photocurrent. The intensity of the light on the photoelectrode influences the linear range of the instrument. However increasing light intensity to too high a value can lead to stability problems with the instrument either emanating from the light source or from photo corrosion of the electrode. A preferred light intensity is within the range of 3 to 10 W/cm² with a value of 6 to 7 W/cm² being preferred.

Solution pH also affects the signal and an operational pH range of 3 to 10 is preferred.

The working electrodes may be regenerated by exposure to UV light and have a useful working life. In addition to the counter electrode it is preferred to also use a reference electrode.

The method of this invention is particularly suitable for an analyzer configured as a probe for testing water samples in the field on a discontinuous basis.

In another aspect this invention provides a probe for determining water quality comprising
a) an electrochemical cell containing a photoactive working electrode, a counter electrode and optionally a reference electrode
b) a supporting electrolyte solution chamber;
c) a light source to illuminate the working electrode
d) sample collection means to provide a volume of sample to the cell
e) control means to
   i) actuate the light source and record the background photocurrent produced at the working electrode from the supporting electrolyte solution;
   ii) add a water sample, to be analysed, to the photoelectrochemical cell;
   iii) actuate the light source and record the steady state photocurrent produced with the sample;
   iv) determine the chemical oxygen demand of the water sample using the formula

$$[ COD ] = \frac{δ}{FAD} \times 8000 {i}_{ss}$$

where δ is the Nernst diffusion layer thickness, D is the diffusion coefficient, A is the electrode area, F the Faraday constant and iₛₛ the steady state photocurrent.

### DESCRIPTION OF THE DRAWINGS

FIG. 1 is a schematic view of the photoelectrochemical cell used in this invention;

FIG. 2 is a graph of a typical photocurrent response of 0.1 M NaClO₄ blank solution;

FIG. 3A shows the quantitative relationship between the net steady state current (iₛₛ) and the molar concentration of organic compounds;

FIG. 3B shows the quantitative relation between the net steady state current (in mA) and nFADC;

FIG. 4A shows the plot of the theoretical and experimental iₛₛ against the theoretical COD values of KHP solution;

FIG. 4 B shows the plot of experimental iₛₛ against the theoretical COD values of KHP and GGA solutions;

FIG. 5A shows the photoelectrochemical oxidation of glucose under different UV light intensities;

FIG. 5B shows the effect of potential on iₛₛ (σ) and i_{blank} (◯) due to the photoelectrochemical oxidation of 0.2 mM glucose and its blank solution, respectively;

FIG. 5 C shows the effect of pH on iₛₛ (σ) and i_{blank} (◯) due to the photoelectrochemical oxidation of 0.2 mM glucose and its blank solution, respectively;

FIG. 6 shows typical GGA standard addition for the determination of the wastewater from a bakery;

FIG. 7 shows the correlation between the PECOD and the standard dichromate COD methods for the real sample measurements.

### DETAILED DESCRIPTION OF THE INVENTION

Materials and Sample Preparation: Indium Tin Oxide (ITO) conducting glass slides (8Ω/square) were commercially supplied by Delta Technologies Limited. Titanium butoxide (97%, Aldrich), and sodium nitrate were purchased from Aldrich without further treatment prior to use. All other chemicals were of analytical grade and purchased from Aldrich unless otherwise stated. High purity deionised water (Millipore Corp., 18MΩcm) was used in the preparation of solutions and the dilution of real wastewater samples.

The real samples used in this study were collected within the State of Queensland in Australia from various industrial sites including wastewater treatment plants, sugar plants, brewery manufacturers, cannery manufacturers and dairy production plants. All samples were preserved according to the guidelines of the standard method. When necessary, the samples were diluted to a suitable concentration prior to the analysis. After dilution, the same sample was subject to analysis by both standard COD method and photoelectrochemical COD detector. To the samples for photoelectrochemical determination, NaClO₄ solid equivalent to 0.1 M was added as supporting electrolyte.

Preparation of TiO₂ film electrodes: Same as previously described in the applicant's prior patent application WO2004088305.

### Apparatus and Methods

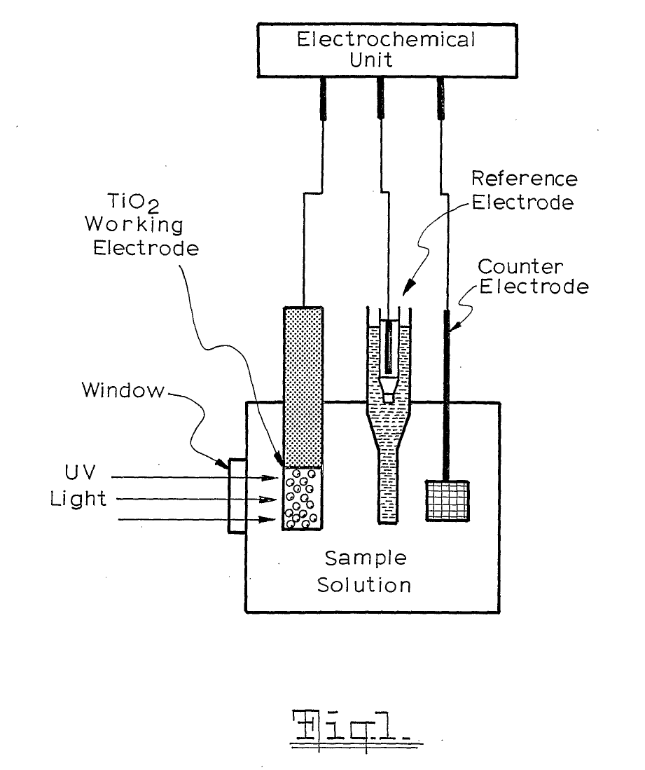

All photoelectrochemical experiments were performed at 23° C. in a three-electrode electrochemical cell with a window for illumination (see FIG. 1). A saturated Ag/AgCI electrode and a platinum mesh were used as the reference and the auxiliary electrodes respectively. A voltammograph (CV-27, BAS) was used for application of potential bias in the photoelectrolysis experiments. Potential and current signals were recorded using a computer coupled to a Maclab 400 interface (AD Instruments). Illumination was carried out using a 150 W xenon arc lamp light source with focusing lenses (HF-200w-95, Beijing Optical Instruments). To avoid the sample solution being heated-up by the infrared light, the light beam was passed through a UV-band pass filters, i.e. UG5 (Avotronics Pty. Limited), prior to illuminating the electrode surface. Standard COD values (dichromate method) of all the samples were measured with a COD analyzer (NOVA 30, Merck). During oxygen dependence experiments, the oxygen concentration was monitored by an oxygen electrode (YSI) and 90 FLMV Microprocessor Field Analyser (from T.P.S. Pty. Ltd.).

### Analytical Signal Measurement

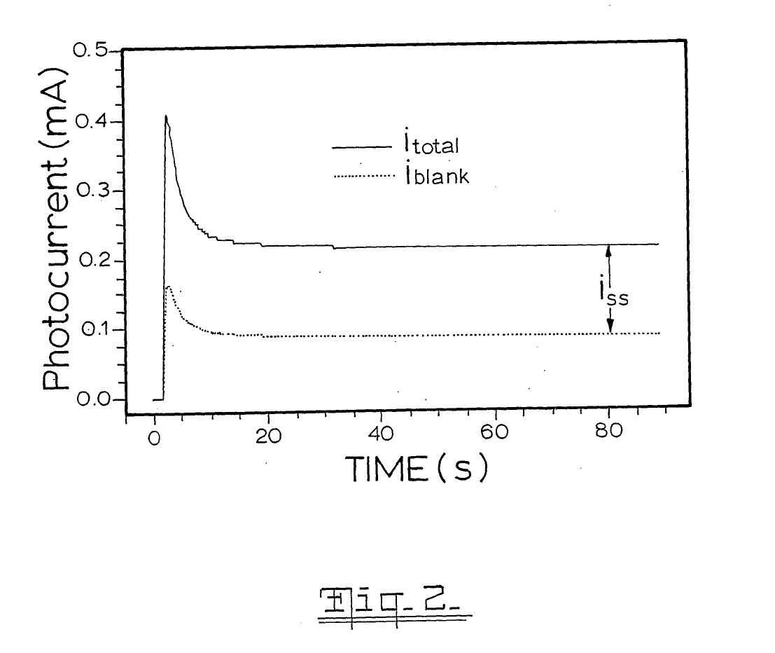

FIGS. 2A and B show a set of typical photocurrent-time profiles obtained in the presence and absence of organic compounds in the photoelectrochemical cell. Under a constant applied potential of +0.30 V, when the light was switched off, the dark current was approximately zero. Upon illumination, the current increased rapidly before decaying to a steady value. For the blank (dash line), the photocurrent (i_{blank}) resulted mainly from the oxidation of water, while photocurrent (iₜₒₜₐₗ) observed from the sample solution containing organics (solid line) is the total current of two current components, one from the oxidation of water, which was the same as the blank photocurrent (i_{blank}), and the other from photoelectrocatalytic oxidation of organic compounds.

The current iₛₛ, the diffusion limiting current originated from the oxidation of organics, can be obtained by subtracting the photocurrent of the blank a (i_{blank}) in the absence of organic compounds from the total photocurrent in the presence of organic compounds (see FIG. 1.2).

iₛₛ=iₜₒₜₐₗ−i_{blank} (1.1)

It has been proved that all organics transported to the TiO₂ electrode surface can be indiscriminately and fully oxidised. Therefore, the net current (iₛₛ) is directly proportional to the rate of electron transfer (the number of electrons transferred per unit of time). As COD is defined as the amount of oxygen required for complete oxidation of organic compounds, subsequently, the net current (iₛₛ) can be used to quantify the COD value of a sample.

### Analytical Signal Quantification

Under the non-exhaustive photocatalytic oxidation model, the quantitative relationship between the iₛₛ and COD of the sample is developed according to the following postulates: (i) the bulk solution concentration remains essentially constant before and after the experiment (non-exhaustive degradation); (ii) all organic compounds at the electrode surface are stoichiometrically oxidized to their highest oxidation state (fully oxidised); (iii) the overall photocatalytic oxidation rate is controlled by the transport of organics to the electrode surface and can reach a steady-state within a reasonable time frame (steady-state mass transfer limited process); (iv) the applied potential bias is sufficient to remove all photoelectrons generated from the photocatalytic oxidation of organics (100% photoelectron collection efficiency).

The rate of steady state mass transfer (dN/dt) to the electrode can be given by a well-known semi-empirical treatment of Steady-State Mass Transfer model:

$$( \frac{d N}{d t} ) = \frac{D}{δ} [ {C}_{b} - {C}_{s} ( x = 0 ) ] \qquad ( 1.2 )$$

where, C_{b} and Cₛ refer to the concentrations of analyte in the bulk solution and at the electrode surface respectively. D and δ are the diffusion coefficient and the Nernst diffusion layer thickness respectively.

Under the steady-state mass transfer limited conditions (Postulate (iii)), the rate of overall reaction equals:

$$Rate = \frac{D}{δ} {C}_{b} \qquad ( 1.3 )$$

According to the postulates (ii) and (iv), the number of electrons transferred (n) during photoelectrochemical degradation is a constant for a given analyte and the steady-state photocurrent (iₛₛ) can, therefore, be used to represent the rate of reaction:

$${i}_{ss} = \frac{nFAD}{δ} {C}_{b} \qquad ( 1.4 )$$

where A and F refer to electrode area and Faraday constant respectively. Equation 1.4 defines the quantitative relationship between the steady-state photocurrent and the concentration of analyte. Converting the molar concentration into the equivalent COD concentration (mg/L of O₂), we have:

$$\begin{matrix}{i}_{ss} = \frac{FAD}{δ} \times \frac{1}{8000} [ COD ] & ( 1.5 a ) \\ [ COD ] = \frac{δ}{FAD} \times 8000 {i}_{ss} & ( 1.5 b )\end{matrix}$$

Equation 1.5b is valid for the determination of COD in a sample which contains a single organic compound. The COD of a sample containing more than one organic species can be represented as:

$$[ COD ] \approx \frac{\overline{δ}}{FAD} \times 8000 {i}_{ss} \qquad ( 1.6 )$$

Where δ̅ is the collective Nernst diffusion layer thickness, which has been proved to be a constant and independent of the type of organics, under diffusion controlled conditions, D̅ is the composite diffusion coefficient that depends on the sample composition and is a constant for a given sample.

### Validation of Analytical Principle

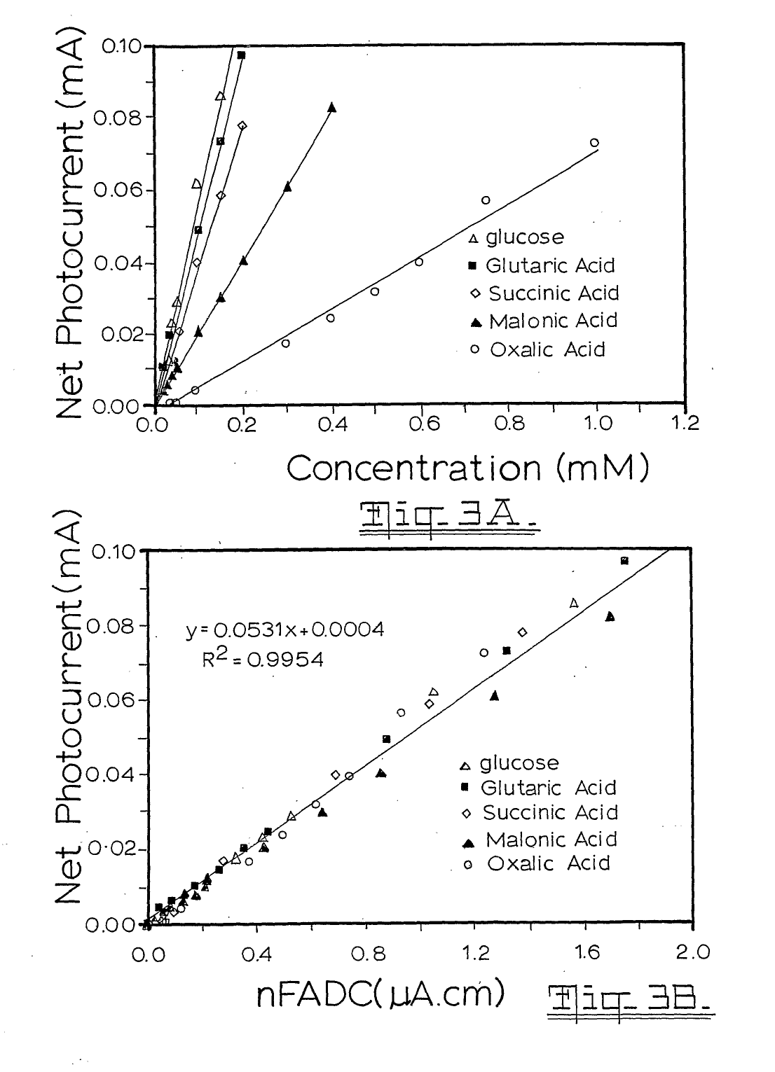

FIG. 3A shows the plots of steady-state photocurrents against the molar concentrations of organic compounds. Linear relationships between iₛₛ and C, as predicted by Equation 1.5, were obtained for all compounds investigated. Further processing of the data in FIG. 3A gives FIG. 3B. Note that all data in FIG. 3B fit into one linear curve of slope=0.0531 and R²=0.995. As the slope of the curve equals δ⁻¹, it can be concluded that, under these experimental conditions, a stagnant diffusion layer thickness (δ=1.86×10⁻³ cm) exists and that this is independent of concentration and type of organic compound. This finding also confirms that the theoretical slope given by Equation 1.5 represents the slope of the curve for each compound in FIG. 1.3a. In fact, we would be not able to obtain the linear line in FIG. 3B unless all of the four above postulates are ratified.

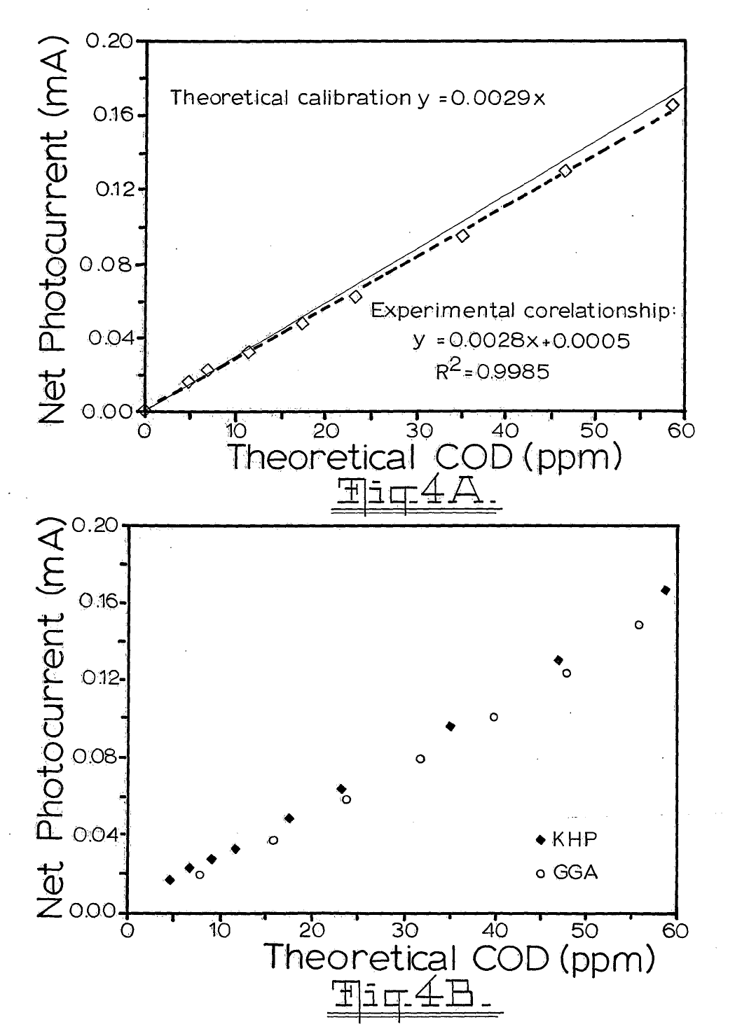

Theoretically, Equation 1.6 should be valid under the same conditions, as required by Equation 1.4. Thus FIGS. 4A and 4B show the plot of iₛₛ against the theoretical COD value of the synthetic samples ([COD]_{theoretical}) prepared with KHP, a test compound for the standard COD method. As predicted by Equation 1.5, a linear relationship between iₛₛ and [COD]_{theoretical} was obtained. The slope of the experimental curve obtained was 2.8×10⁻³ mA (mg/L of O₂)⁻¹ with R²=0.9985. The theoretical curve calculated from Equation 1.5 was also given in the FIG. 4A (solid line) for comparison. When n=30e⁻, D=6.96×10⁻³ cm²s⁻¹ [ref] and δ=1.86×10⁻³ cm were used, the theoretical slope calculated according to Equation 1.5 was 2.9×10⁻³ mA (mg/L of O₂)⁻¹. These almost identical theoretical and experimental slope values prove the applicability of Equation 1.5 for COD determination.

The applicability of Equation 1.6 was examined using a GGA synthetic sample. The GGA synthetic sample is a mixture of glucose and glutamic acid, which has typically has been used as a standard test solution for BOD analysis.

As predicted by Equation 1.6, the steady-state photocurrent, iₛₛ, is directly proportional to the sample [COD] (see FIG. 1.4b). However, application of Equation 1.6 for real samples requires calibration, since the composite diffusion coefficient, D̅, is not known. Unlike other analyses, the definition of a calibration standard for COD analysis is difficult since COD is an aggregative quantity. In practice, a COD calibration standard can only be selected by experimental means. Two essential criteria should be satisfied by the selected calibration standard: (i) the calibration standard should possess an equivalent D̅ value to the original sample and (ii), it can be fully oxidized. These criteria reflect the experimental observation that the added calibration standard causes a steady-state photocurrent change which follows the same slope of the original sample.

### Optimisation of Analytical Signal

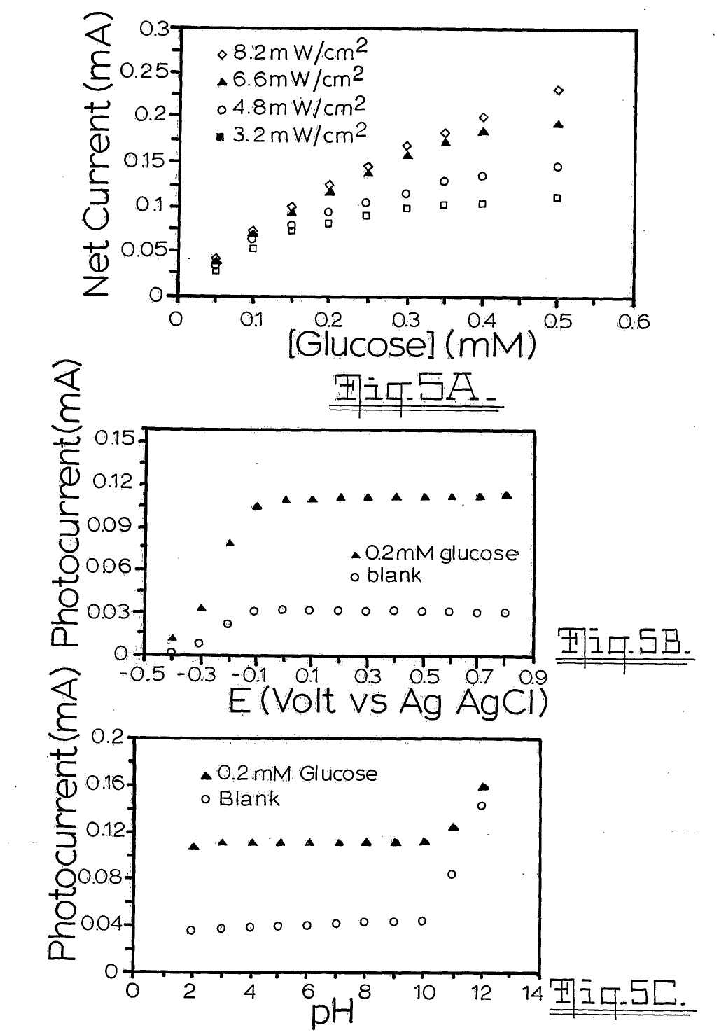

The effect of light intensity on the steady-state photocurrent was examined (see FIG. 5A). It is notable that the change of the light intensities has a dramatic influence on the linear range. An increase in the light intensity leads to an increase in linear range. The iₛₛ deviations from the linear relationship relate to the rate of the photocatalytic oxidation being slower than that of mass transfer to the electrode. Increasing light intensity leads to an increase in the rate of photohole generation, which, in effect, increases the rate of photocatalytic oxidation. That is, a high light intensity can sustain the overall process under the mass transfer controlled conditions at higher concentrations. Thus, to provide a wide linear range and good operating conditions, a relatively low (but sufficient) light intensity (6.6 mW/cm²) was employed.

For a particulate TiO₂ semiconductor electrode, the applied potential bias serves the function of collecting the electrons made available by the interfacial photocatalytic reactions. 100% photoelectron collection efficiency (Postulate (iv)—see Analytical Signal Quantification section) can be achieved only when the applied potential bias is sufficient. FIG. 5B shows the effect of potential bias on both iₛₛ and i_{blank}. It reveals that both iₛₛ and i_{blank} becomes constant when the applied potential bias is more positive than −0.05V vs Ag/AgCI indicating 100% photoelectron collection efficiency. To ensure the selected potential bias is applicable under various conditions and at the same time, to avoid direct electrochemical reaction, a standard potential bias of +0.30V vs Ag/AgCl was selected.

It is well known that the solution pH affects the flat band and the band edge potentials of TiO₂ semiconductors in a Nernstian fashion. The solution pH also affects the speciation of both surface functional groups of the semiconductor electrode and the chemical forms of organic compounds in the solution. These pH dependent factors may affect the analytical signal. FIG. 5C shows the effect of pH on both iₛₛ and i_{blank}. Within the pH range of 2 to 3, both iₛₛ and i_{blank} increased slightly as the solution pH was increased. Within the pH range of 3 to 10, both iₛₛ and i_{blank} were insensitive to the solution pH change. When the solution pH was above 10, the iₛ, observed was relatively insensitive to the pH change, but a sharp increase in the i_{blank} with the solution pH was observed due to the rate of water oxidation was greatly enhanced at high pH. The sensitivity of i_{blank} towards the solution pH may cause problems for accurate measurement of iₛₛ. Therefore, a solution pH range from 3 to 10 is preferred. This pH range is suitable for most of the environmental samples (pH 3-10) that can be used without the needs for pH adjustment.

### Real Sample Analyses

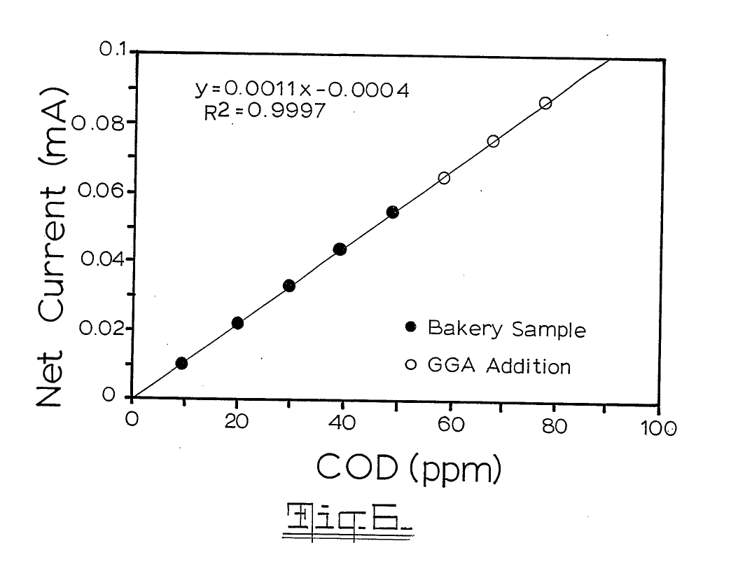

The analysis of real samples was conducted. These real samples were collected from various industrial sites. The pH of the real samples tested in this paper was in the range of 6-8, i.e., in the pH independent region. For the analysis of very high COD samples, dilution with NaClO₄ or NaNO₃ solution will normally bring the pH in the range of 5-8 and the O₂ concentration in the range of 5-9.5 mgL⁻¹. To minimize any matrix effect, if required, the standard addition method can be used for the photoelectrochemical determination of COD value of real samples and so ensure that the D̅ value is constant and consistent during the calibration and measurement. The results shown in FIG. 6 confirm that Equation 1.6 can be used to determine COD values of real samples.

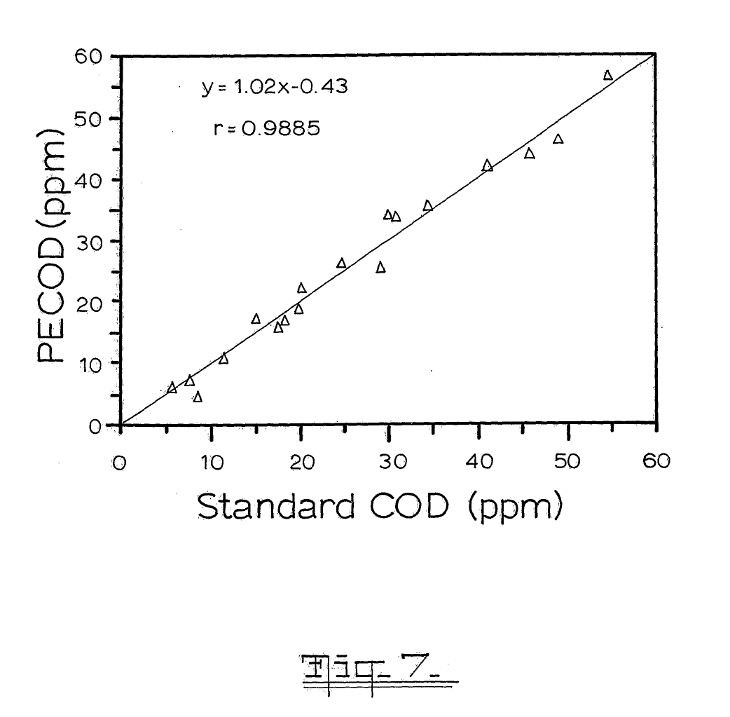

FIG. 7 shows the correlation between the experimental COD values and standard COD values. The standard COD value was determined with the conventional COD method (dichromate method). Where valid, the Pearson Correlation coefficient was used as a measure of the intensity of association between the values obtained from the photoelectrochemical COD method and the conventional COD method. A highly significant correlation (r=0.988, P=0.000, n=18) between the two methods was obtained indicating the two methods agreed very well. The slope of the graph was 1.02. This near unity slope indicates that both methods were accurately measuring the same COD value. Given a 95% confidence interval, this slope was between 0.96 and 1.11, which implies a 95% confidence level that the true slope lies between these two values. Considering that there are analytical errors associated with both the photoelectrochemical COD and the standard method measurements, and that these errors contribute to scatter on both axes, the strong correlation and slope obtained provides compelling support for the suitability of the photoelectrochemical COD method for measuring Chemical Oxygen Demand.

It is found that the detection limit of 0.8 mgL⁻¹ COD with linear range up to 70 mgL-1 COD can be achieved under the above optimised experimental conditions. The detection range may be extended by proper dilution as aforementioned. A reproducibility of 2.2% RSD was obtained from 19 analyses of 50 μM KHP.

From the above, it can be seen that this invention provides an improved method and a probe for use in conducting non-exhaustive COD analyses of water samples.

Those skilled in the art will realize that this invention may be implemented in embodiments other than those described without departing from the core teachings of the invention.

1. A method of determining chemical oxygen demand (COD) of a water sample, comprising the steps of
a) applying a constant potential bias to a photoelectrochemical cell, having a photoactive working electrode and a counter electrode, and containing a supporting electrolyte solution;
b) illuminating the working electrode with a light source and recording the background photocurrent produced at the working electrode from the supporting electrolyte solution;
c) adding a water sample, to be analysed, to the photoelectrochemical cell;
d) illuminating the working electrode with a light source and recording the steady state photocurrent produced with the sample;
e) determining the chemical oxygen demand of the water sample using the formula
$$[ COD ] = \frac{δ}{FAD} \times 8000 {i}_{ss}$$
where δ is the Nernst diffusion layer thickness. D is the diffusion coefficient. A is the electrode area, F the Faraday constant and iₛₛ the steady state photocurrent.

2. A method as claimed in claim 1 wherein the pH of the water sample is within the range of 3 to 10.

3. A method as claimed in claim 1 wherein the photo electrode is a titanium dioxide nanoparticulate photo electrode.

4. A probe for determining water quality comprising
a) an electrochemical cell containing a a photoactive working electrode and a counter electrode,
b) a supporting electrolyte solution chamber;
c) a light source to illuminate the working electrode
d) sample collection means to provide a volume of sample to the cell
e) control means to
i) actuate the light source and record the background photocurrent produced at the working electrode from the supporting electrolyte solution;
ii) add a water sample, to be analysed, to the photoelectrochemical cell;
iii) actuate the light source and record the steady state photocurrent produced with the sample;
iv) determine the chemical oxygen demand of the water sample using the formula
$$[ COD ] = \frac{δ}{FAD} \times 8000 {i}_{ss}$$
where δ is the Nernst diffusion layer thickness, D is the diffusion coefficient, A is the electrode area, F the Faraday constant and iₛₛ the steady state photocurrent;

5. A probe as claimed in claim 4 wherein the photo electrode is a titanium dioxide nanoparticulate photo electrode.

6. A probe as claimed in claim 4 in which the light intensity is from 3 to 10 W/cm².
